(19) United States
(12) Patent Application Publication
(10) Pub. No.: US 2009/0154801 A1
(43) Pub. Date: Jun. 18, 2009

(54) SYSTEM AND METHOD FOR AUTOMATICALLY ADJUSTING A DISPLAY PANEL

(75) Inventor: MENG-CHIEH CHOU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 12/331,379

(22) Filed: Dec. 9, 2008

(30) Foreign Application Priority Data
Dec. 12, 2007 (CN) 200710203023.2

(51) Int. Cl. G06K 9/00; G06K 9/46

(52) U.S. Cl. 382/165; 382/195

(57) ABSTRACT

A system for adjusting position of a display panel is provided. The system captures a reference facial image and a present facial image of a user at different time frames, and calculates adjustment parameters according to the reference facial image and the present facial image. The display panel is then driven to a proper position according to the adjusting parameters.

### FIELD OF THE INVENTION

Embodiments of the present disclosure relate to adjusting a display, and more particularly to a system and method for automatically adjusting a display panel.

### DESCRIPTION OF RELATED ART

A display is an important device of a computer. A user sometimes needs to manually adjust the display panel to get a better view when viewing the display panel from different locations or positions. However, manual adjustment is a bit inconvenient for the user.

What is needed, therefore, is a system and method for automatically adjusting a display panel to provide a suitable viewing angle for a current user.

### BRIEF DESCRIPTION OF THE DRAWINGS

FIG. 1 is a block diagram of one embodiment of a system for automatically adjusting a display panel.

FIG. 2 is a block diagram of one embodiment of an adjustment control unit comprising function modules.

FIG. 3 is a flowchart of one embodiment of a method for adjusting a display panel.

FIG. 4 illustrates one embodiment of reference facial features.

FIG. 5 illustrates one embodiment of present facial features.

### DETAILED DESCRIPTION OF CERTAIN INVENTIVE EMBODIMENTS

All of the processes described below may be embodied in, and fully automated via, software code modules executed by one or more general purpose computers or processors. The code modules may be stored in any type of computer-readable medium or other computer storage device. Some or all of the methods may alternatively be embodied in specialized computer hardware.

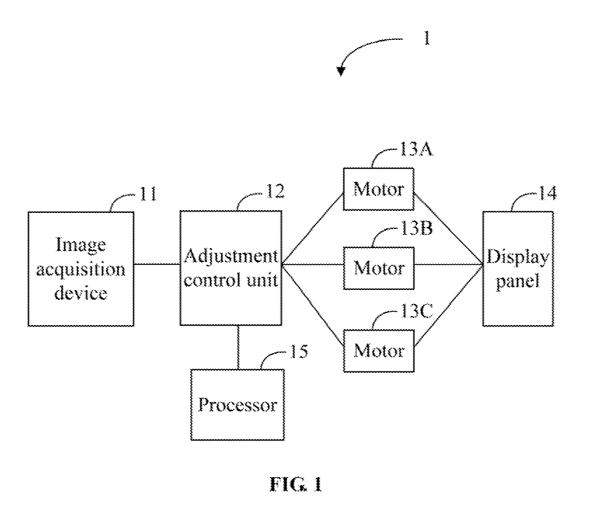

FIG. 1 is a block diagram of one embodiment of a system 1 for automatically adjusting a display panel 14 according to a position of a user of the display panel 14. The system 1 may comprise an image acquisition device 11, an adjustment control unit 12, and motors 13A-13C. The adjustment control unit 12 is connected to the image acquisition device 11 and the motors 13A-13C. The motors 13A-13C are connected to the display panel 14. The system 1 further comprises a processor 15 to execute the adjustment control unit 12.

The image acquisition device 11 is used for capturing a reference facial image and a present facial image of the user at a first and second time frame respectively, and sending the reference facial image and the present facial image to the adjustment control unit 12. The reference facial image may be a first facial image of the user in a reference position, for example, directly in front of the display panel 14. The present facial image may be a second facial image of the user in a present position while the user is using the display panel 14, which may be different from the reference position. Time differences between the user in the reference position and the present position may depend on the embodiment. In one embodiment, the image acquisition device 11 may be an electronic device that can capture digital images, such as a pickup camera, or a universal serial bus (USB) webcam. The image acquisition device 11 may capture digital color images of the user.

The adjustment control unit 12 is used for controlling the image acquisition device 11 to capture the reference facial image and the present facial image. The adjustment control unit 12 further determines if the present facial image matches the reference facial image. If the present facial image does not match the reference facial image, then the user is in a different position. Accordingly, the adjustment control unit 12 calculates adjustment parameters, and controls the motors 13A-13C to drive the display panel 14 to a proper position according to the adjusting parameters. The adjustment parameters may determine a rotational direction and a rotational degree of the display panel 14. In one embodiment, a change in position may mean the user has shifted to a different location in the room where the display is, or a change in position may mean the user is still in front of the display but is sitting lower or standing up or shifted somewhat to one side or the other. In one embodiment, it is assumed that the user is looking at the display panel 14. Thereby, changes of certain points on the face of the user in a captured image can allow calculation of the nature of the positional shift of the user so that the display panel 14 can be adjusted accordingly.

The motors 13A-13C drive the display panel 14 according to the adjusting parameters. In the embodiment, the motors 13A-13C are respectively used to adjust a height, a vertical angle, and a horizontal angle of the display panel 14. In one embodiment, each of the motors 13A-13C may be a direct current motor, such as a permanent magnet direct current motor, or an alternating current motor, such as a synchronous motor.

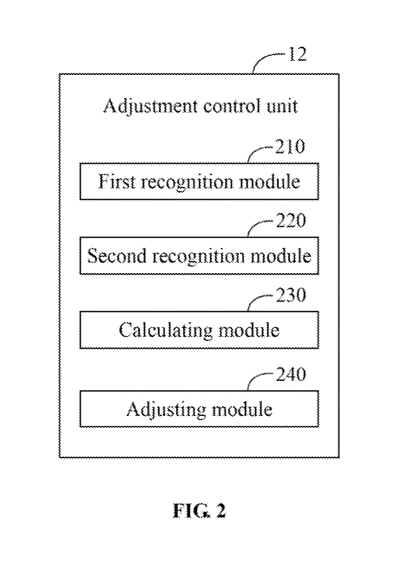

FIG. 2 is a block diagram of one embodiment of an adjustment control unit 12 comprising function modules. In one embodiment, the adjustment control unit 12 may include a first recognition module 210, a second recognition module 220, a calculating module 230, and an adjusting module 240. One or more specialized or general purpose processors, such as the processor 15 may be used to execute the first recognition module 210, the second recognition module 220, the calculating module 230, and the adjusting module 240.

The first recognition module 210 is configured for controlling the image acquisition device 11 to capture a reference facial image of the user, and extracting reference facial features from the reference facial image. In one embodiment, the first recognition module 210 converts the reference facial image into a reference gray image, and extracts reference facial features based on the reference gray image.

The second recognition module 220 is configured for controlling the image acquisition device 11 to capture a present facial image of the user while the user is using the display, and extracting present facial features from the present facial image. The present facial features are the same as the reference facial features. In one embodiment, the second recognition module 220 converts the present facial image into a present gray image, and extracts present facial features based on the present gray image.

The calculating module 230 is configured for calculating adjustment parameters according to differences between the reference facial features and the present facial features.

The adjusting module 240 is configured for controlling the motors 13A-13C to drive the display panel 14 to a proper position according to the adjusting parameters.

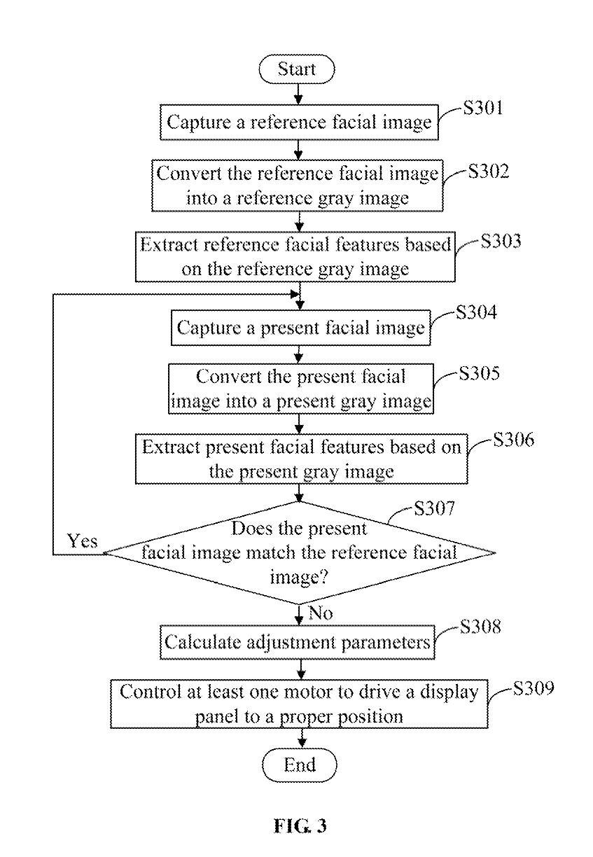

FIG. 3 is a flowchart of one embodiment of a method for adjusting a display panel 14 by implementing the system of FIG. 1. The method of FIG. 3 may be used to adjust the display panel 14 to a proper position. Depending on the embodiments, additional blocks may be added, others removed, and the ordering of the blocks may be changed.

In block S301, the first recognition module 210 controls the image acquisition device 11 to capture a reference facial image of a user. The reference facial image may be a first facial image of the user in a reference position, for example, directly in front of the display panel 14. In one embodiment, the reference facial image may be a digital color image.

In block S302, the first recognition module 210 converts the reference facial image into a reference gray image. In one embodiment, the reference facial image may be an RGB (red, green, blue) image consisting of a plurality of pixels. Each of the plurality of pixels may be characterized by a red component, a green component, and a green component. A gray value can be derived from the red component, the green component, and the green component. In one embodiment, one example of a formula to determine the gray value may be as follows:

gray=red×a+green×b+blue×c,

wherein gray is a gray value of a pixel, red, green and blue are respectively a red, green, and blue component of the pixel, a, b, and c are constants. In one embodiment, a is 0.3, b is 0.59, c is 0.11. As such, the first recognition module 210 converts the reference facial image into a reference gray image by calculating the gray value of each pixel in the reference facial image.

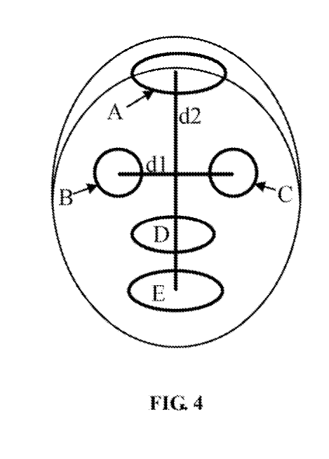

In block S303, the first recognition module 210 extracts reference facial features based on the reference gray image. In one embodiment, the facial features extracted by the first recognition module 210 may include segments of topmost point of the forehead such as at the hairline directly above the nose, eyes, nose, and mouth. It may be understood that various image processing methods, such as image segmentation methods may be used to obtain such segments from the reference gray image. FIG. 4 illustrates one embodiment of the reference facial features denoted as circles A, B, C, D and E. The circles A, B, C, D and E respectively denote the topmost point of the forehead, the eyes, the nose, and the mouth of the person. Accordingly, a distance between the eyes (shown as “d1”), and a distance between the topmost point of the forehead and the mouth (shown as “d2”) are derived.

In block S304, the second recognition module 220 controls the image acquisition device 11 to capture a present facial image of the user. The present facial image may be a second facial image of the user in a present position while the user is using the display panel 14, which may be different from the reference position. In one embodiment, the present facial image may be a digital color image.

In block S305, the second recognition module 220 converts the present facial image into a present gray image. In one embodiment, the second recognition module 220 converts the present facial image into the present gray image using the method as described in block S302.

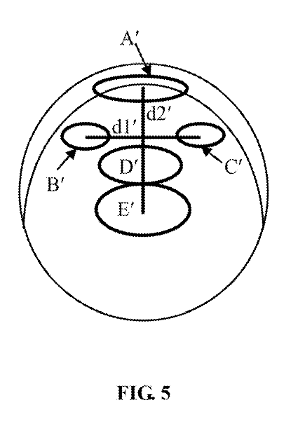

In block S306, the second recognition module 220 extracts present facial features based on the present gray image. In one embodiment, the present facial features include segments of topmost point of the forehead, eyes, nose, and mouth of the user, which are same as the reference facial features. In one embodiment, the second recognition module 220 extracts the present facial features using the method as described in block S303. FIG. 5 illustrates one embodiment of the present facial features denoted as circles A′, B′, C′, D′ and E′. The circles A′, B′, C′, D′ and E′ respectively denote the topmost point of the forehead, the eyes, the nose, and the mouth. Accordingly, a distance between the eyes (shown as “d1′”), and a distance between the topmost point of the forehead and the mouth (shown as “d2′”) are derived.

In block S307, the calculating module 230 determines if the present facial image matches the reference facial image by respectively comparing each of the reference facial features with the corresponding present facial feature. If the present facial image matches the reference facial image, the flow return to block S304. In one embodiment, referring to FIG. 4 and FIG. 5, the calculating module 230 firstly compares the distance d1 with the distance d1′, and then compares the distance d2 with distance d2′. If the distance d1 does not equal or approach the distance d1′, or the distance d2 does not equal or approach the distance d2′, the calculating module 230 determines that the present facial image does not match the reference facial image. If the distance d1 is equal to the distance d1′, and the distance d2 is equal to the distance d2′, the calculating module 230 determines that the present facial image matches the reference facial image.

If the present facial image matches the reference facial image, the flow returns to block S304. Otherwise, if the present facial image does not match the reference facial image, then the user is in a different position. In block S308, the calculating module 230 calculates adjusting parameters according to the differences between the reference facial features and the present facial features. The adjustment parameters may determine a rotational direction and a rotational degree of the display panel 14. In one embodiment, a change in position may mean the user is still in front of the display but has sat lower or stood up or shifted to one side or the other. Referring to FIG. 4 and FIG. 5, a change in position may be determined as follows: if a distance between the eyes is decreased, i.e. d1′<d1, then the user has shifted to one side or the other; if a distance between the topmost point of the forehead and the mouth is decreased, i.e. d2′<d2, then the user has stood up or sat lower.

In block S309, the adjusting module 240 controls the motors 13A-13C to drive the display panel 14 to a proper position according to the adjustment parameters. For example, if the user has shifted to one side, then the motor 13C drives the display panel 14 also rotate to the side, i.e. adjusting a horizontal angle of the display panel 14.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for automatically adjusting a display panel according to a position of a user of the display panel, the system comprising:
a first recognition module configured for controlling an image acquisition device to capture a reference facial image of a user at a first time frame, and extracting reference facial features from the reference facial image;
a second recognition module configured for controlling the image acquisition device to capture a present facial image of the user at a second time frame, and extracting present facial features from the present facial image, wherein the second time frame is at a later time frame from the first time frame;
a calculating module configured for calculating adjustment parameters according to differences between the reference facial features and the present facial features;
an adjusting module configured for controlling at least one motor to drive the display panel to a proper position according to the adjustment parameters; and
at least one processor executing the first recognition module, the second recognition module, the calculating module, and the adjusting module.

2. The system of claim 1, wherein the first recognition module extracts reference facial features by converting the reference facial image into a reference gray image, and the second recognition module extracts present facial features by converting the present facial image into a present gray image.

3. The system of claim 1, wherein the reference facial image and the present facial image are RBG (red, blue, green) images, wherein each RGB image comprises a plurality of pixels.

4. The system of claim 3, wherein the first recognition module converts the reference facial image into a reference gray image, and the second recognition module converts the present facial image into a present gray image according to a formula as follows:
gray=red×0.3+green×0.59+blue×0.11
wherein gray is a gray value of a pixel, red is a red component of the pixel, green is a green component of the pixel, and blue is a blue component of the pixel.

5. The system of claim 1, wherein both of the reference facial features and the present facial features comprise segments of topmost point of the forehead, eyes, nose, and mouth of the user.

6. A computer-implemented method for automatically adjusting a display panel according to a position of a user of the display panel, the method comprising:
controlling an image acquisition device to capture a reference facial image of a user at a first time frame, and extracting reference facial features from the reference facial image;
controlling the image acquisition device to capture a present facial image of the user at a second time frame, and extracting present facial features from the present facial image, wherein the second time frame is at a later time frame from the first time frame;
calculating adjustment parameters according to differences between the reference facial features and the present facial features; and
controlling at least one motor to drive the display panel to a proper position according to the adjustment parameters.

7. The method of claim 6, wherein the reference facial image is converted into a reference gray image, and the reference facial features are extracted based on the reference gray image.

8. The method of claim 6, wherein the present facial image is converted into a present gray image, and the present facial features are extracted based on the present gray image.

9. The method of claim 6, wherein the reference facial image and the present facial image are RBG (red, blue, green) images, wherein each RGB image comprises a plurality of pixels.

10. The method of claim 9, wherein the reference facial image is converted into a reference gray image and the present facial image is converted into a present gray image according to a formula as follows:
gray=red×0.3+green×0.59+blue×0.11
wherein gray is a gray value of a pixel, red is a red component of the pixel, green is a green component of the pixel, and blue is a blue component of the pixel.

11. The method of claim 6, wherein both of the reference facial features and the present facial features comprise segments of topmost point of the forehead, eyes, nose, and mouth of the user.

12. A computer-readable medium having stored thereon instructions that, when executed by a computerized device, cause the computerized device to execute a computer-implemented method comprising:
controlling an image acquisition device to capture a reference facial image of a user at a first time frame, and extracting reference facial features from the reference facial image;
controlling the image acquisition device to capture a present facial image of the user at a second time frame, and extracting present facial features from the present facial image, wherein the second time frame is at a later time frame from the first time frame;
calculating adjustment parameters according to differences between the reference facial features and the present facial features; and
controlling the at least one motor to drive the display panel to a proper position according to the adjustment parameters.

13. The medium of claim 12, wherein the reference facial image is converted into a reference gray image, and the reference facial features are extracted based on the reference gray image.

14. The medium of claim 12, wherein the present facial image is converted into a present gray image, and the present facial features are extracted based on the present gray image.

15. The medium of claim 12, wherein the reference facial image and the present facial image are RBG (red, blue, green) images, wherein each RGB image comprises a plurality of pixels.

16. The medium of claim 15, wherein the reference facial image is converted into a reference gray image and the present facial image is converted into a present gray image according to a formula as follows:
gray=red×0.3+green×0.59+blue×0.11
wherein gray is a gray value of a pixel, red is a red component of the pixel, green is a green component of the pixel, and blue is a blue component of the pixel.

17. The medium of claim 12, wherein both of the reference facial features and the present facial features comprise segments of topmost point of the forehead, eyes, nose, and mouth of the user.
